(19) United States
(12) Patent Application Publication
(10) Pub. No.: US 2009/0114722 A1
(43) Pub. Date: May 7, 2009

(54) Card Reader With Capability Of Adjusting Access Interface Display

(76) Inventors: Bei-Chuan Chen, Hsinchu (TW); Li-Hsiang Chan, Hsinchu (TW); Che-Wei Chang, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/935,406

(22) Filed: Nov. 6, 2007

(51) Int. Cl. G06K 7/06

(52) U.S. Cl. 235/441

(57) ABSTRACT

A card reader with capability of adjusting the access interface display is provided, including a connection interface for electrically connecting to the host, a plurality of access interfaces for electrically connecting to corresponding memory cards, such as SD, CF, and a controller. When the host completes the enumeration, the controller issues a disconnect signal through the connection interface to the host to erase the original disk mappings, such as G:, F:, on the display for subsequent adjustment. For adjusting the display, the controller issues an optional reconnect signal belonging to the card reader to the host so that the host can execute the re-enumeration and adjust the displaying of the access interface available in the card reader according to the optional reconnect signal.

### FIELD OF THE INVENTION

The present invention generally relates to a card reader, and more specifically to a card reader with the capability of adjusting access interface display.

### BACKGROUND OF THE INVENTION

The flash memory consists of a plurality of transistor memory cells, and the data storage and erase is through the Fowler-Nordheim tunnel injection, which causes a large amount of current passing through the dielectric layer on the side of the floating gate (FG) of the transistor memory cells during data access.

The storage media using flash memory has the advantages of small size, and thus many varieties are widely used, including secured digital (SD) card, multimedia card (MMC), smart media (SM) card, memory stick (MS) card, compact flash (CF) card, and XD picture memory card.

However, as the demands on further reduction of size, the above-mentioned SD, MMC and MS cards are no longer satisfactory for many users. Therefore, the even smaller specifications, such as Mini SD, Micro SD, and M2 by Sony, are made. For example, the size of M2 is about ¼ of the size the currently smallest MS Pro Duo, and the thickness is around 1.2 mm.

To allow the host, such as PC and PDA, to read the data from various flash memory cards, a multi-card reader, such as Taiwan Patent No. M278972, is required. However, the conventional multi-card reader usually imposes some inconvenience in use although the multi-card reader provides the capability to access data in various specifications.

When a single-card reader is connected to a host, the OS of the host will automatically arrange a corresponding disk mapping to the card reader and use an application such as file manager to access the memory card plugged in the card reader. However, for a multi-card reader, the OS will assign a plurality of disk mappings, such as F:, G:, H:, to each different access interface, such as SD, CF, xD. But, in the file manager, the disk mapping is not marked to indicate which access interface the disk mapping is mapped to. Therefore, the user must click on each disk mapping to find out the mapping and then use the file manager to access the plugged-in memory card.

### SUMMARY OF THE INVENTION

The primary object of the present invention is to provide a card reader with the capability of adjusting the access interface display. The card reader issues a disconnect signal and an optional reconnect signal to the host, and the host can execute the re-enumeration and adjust the access interface display according to the optional reconnect signal.

To achieve the above object, the card reader with capability of adjusting the access interface display of the present invention includes a connection interface for electrically connecting to the host, a plurality of access interfaces for electrically connecting to corresponding memory cards, such as SD, CF, and a controller. When the host completes the enumeration, the controller issues a disconnect signal through the connection interface to the host to erase the original disk mappings, such as G:, F:, on the display for subsequent adjustment. For adjusting the display, the controller issues an optional reconnect signal belonging to the card reader to the host so that the host can execute the re-enumeration and adjust the displaying of the access interface available in the card reader according to the optional reconnect signal.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIGS. 1A-1C show a schematic view of a card reader with capability of adjusting the access interface display of the present invention; and

FIGS. 2A-2D show a schematic view of an embodiment of a card reader with capability of adjusting the access interface display of the present invention.

### DETAILED DESCRIPTION OF THE PREFERRED EMBODIMENTS

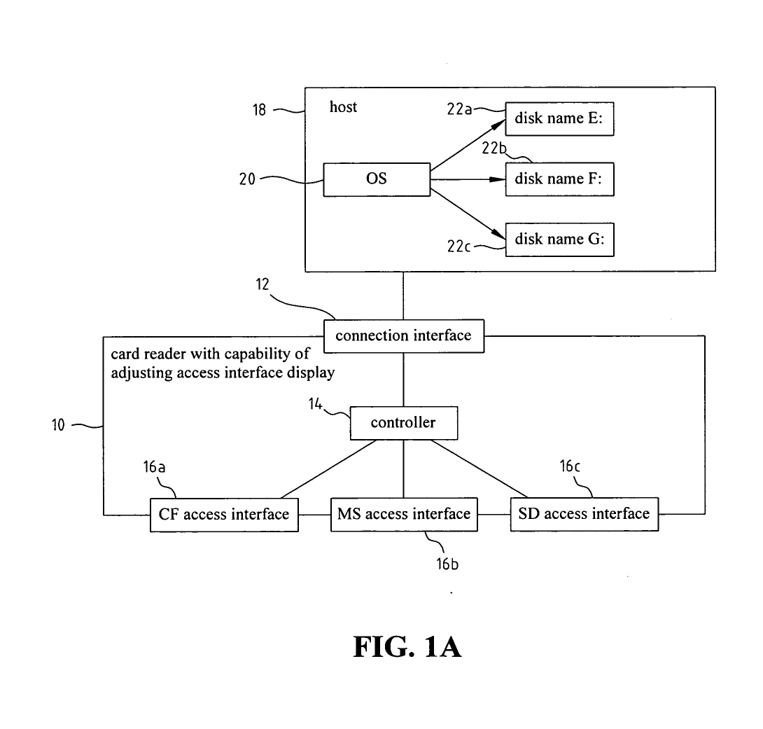

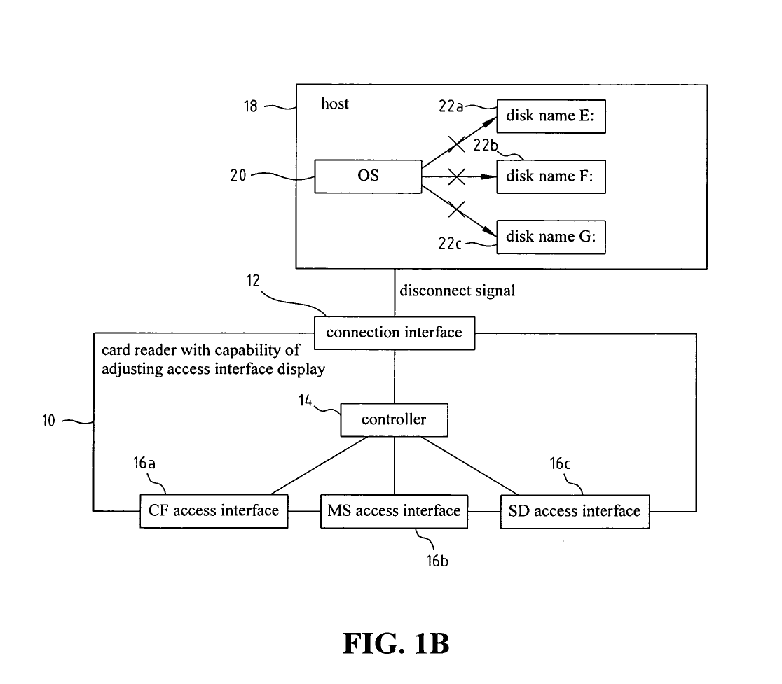

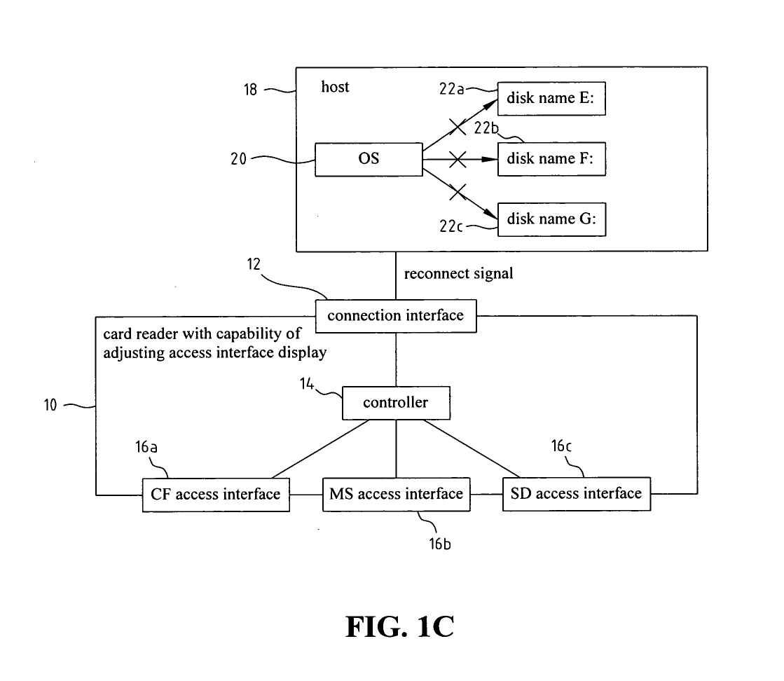

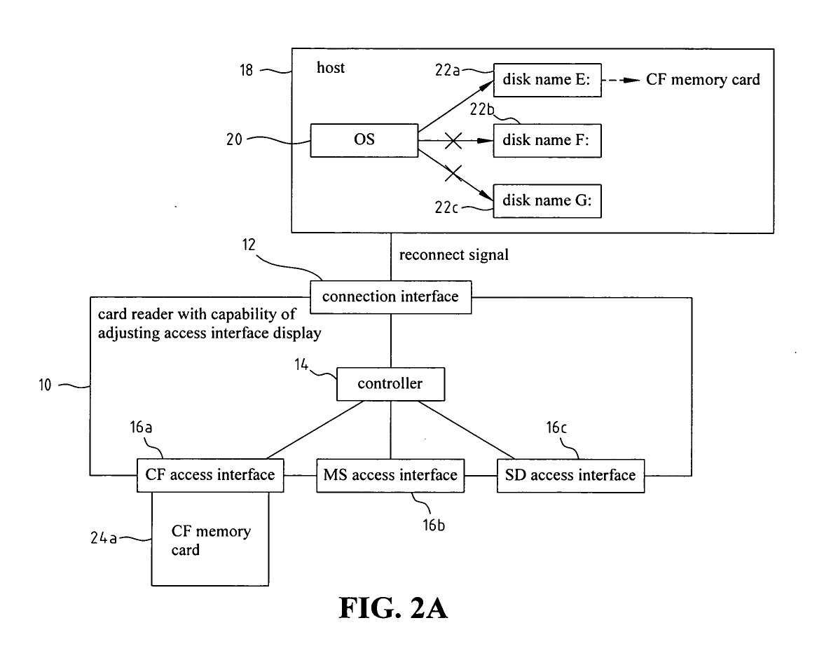

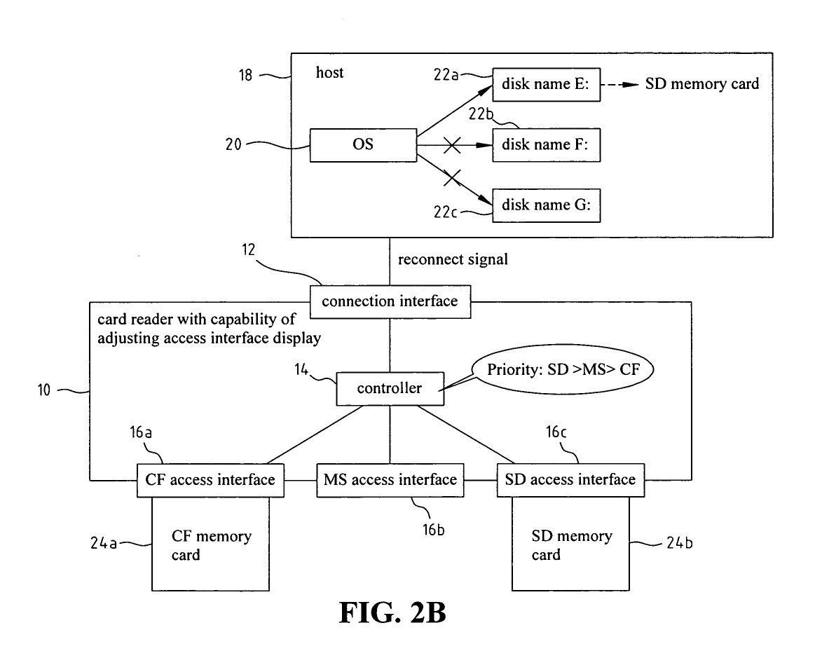

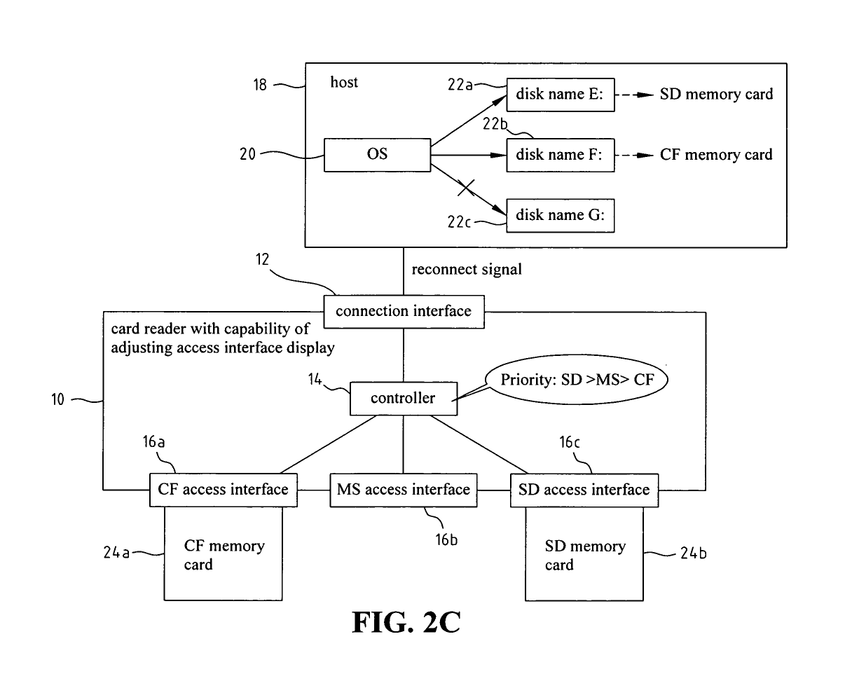

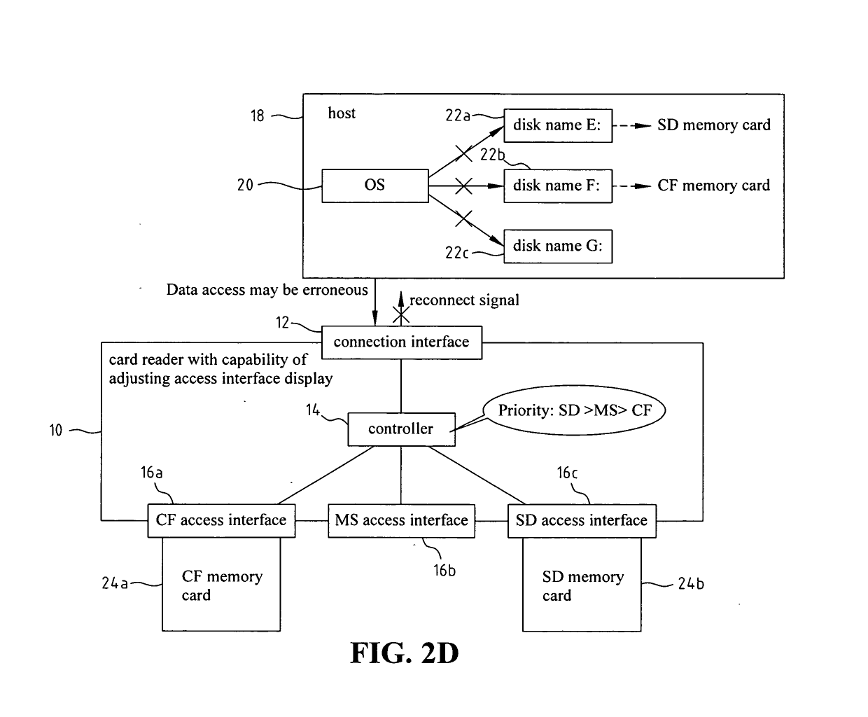

FIGS. 1A-1C show a schematic view of a card reader with capability of adjusting access interface display. As shown in FIG. 1A, a card reader 10 with capability of adjusting access interface display includes a connection interface 12, a controller 14, and a plurality of access interfaces 16a-16c. Connection interface 12 is electrically connected to a host 18 through a cable so that host 18 and card reader 10 can communicate with each other. Access interfaces are for providing access to various memory cards. For example, access interface 16a can support CF, access interface 16b supports MS and access interface 16c supports SD, and all are electrically connected to corresponding memory cards 24a, 24b, as shown in FIG. 2B. Connection interface 12 can be a USB interface, and controller 14 can be a USB controller.

The aforementioned memory cards can be secured digital (SD) card, Mini SD card, multimedia card (MMC), reduced-size MMC (RS-MMC), TransFlash (T-Flash), Mega-SIM card, smart media (SM) card, memory stick (MS) card, MS Pro, MS Duo, MS Pro Duo, M2 card, compact flash (CF), or XD picture memory card.

In general, when host 18 and card reader 10 complete the electrical connection, they will use the USB protocol for configuration. After host 18 completes enumeration, an OS 20 will map access interfaces 16a-16c of card reader 10 to disk name 22a-22c, as shown in FIG. 1A. However, for the user, the mapping between the access interface and the disk names is not clear to the use.

To alleviate the inconvenience, controller 14 can issue a disconnect signal belonging to card reader 10 through connection interface 12 to host 18 to erase the disk names displayed originally, such as G:, F:, for subsequent adjustment, as shown in FIG. 1B.

To adjust the display of the access interfaces, controller 14 issues an optional reconnect signal belonging to card reader 10 to host 18 so that host 18 can execute the re-enumeration and display the available access interfaces in card reader 10 according to the optional reconnect signal, as shown in FIG. 1C. The following describes the optional reconnect signal and how host 18 adjusts the display of the access interfaces.

FIGS. 2A-2D show an embodiment of a card reader with capability of adjusting access interface display of the present invention. As shown in FIG. 2A, card reader 10 will execute corresponding process according to whether a memory card 24a is plugged into access interface 16a-16c. For example, if a CF memory card 24a is plugged into CF access interface 16a, controller 14 will issue a reconnect signal belonging to card reader 10 to host 18 so that host 18 executes re-enumeration and only displays access interface 16a, which has a memory card 24a is plugged into. That is, only disk name E: is displayed, and the other disk names are not. If more than a memory card is plugged into, controller 14 will execute the corresponding process according to the priority.

As shown in FIG. 2B, for example, the priority can be SD>MS>CF. When controller 14 issues the reconnect signal belonging to card reader 10 to host 18, host 18 displays access interface 16c which a memory card 24b is plugged into and is with the highest priority according to the priority of the access interfaces. That is, disk name E: is mapped to the highest priority SD card 24b. In addition, as shown in FIG. 2C, host 18 can also display in order, based on the priority of the access interfaces, access interfaces 16c, 16a which memory cards 24b, 24a have been plugged into; i.e., disk names E:, F: are mapped to memory cards 24b, 24a, respectively. However, if the data access may be erroneous, a reconnect signal is no longer issued to avoid the data error or loss caused by accessing the memory card as shown in FIG. 2D.

Furthermore, controller 14 will continue monitoring the usage status of access interface 16a-16c. Whenever a memory card 24b, 24a is plugged into or unplugged from the access interfaces, controller 14 will re-adjust the display in the same manner until card reader 10 and host 18 disconnect from each other.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A card reader with capability for adjusting access interface display, comprising:
a connection interface, for electrically connecting to a host;
a plurality of access interfaces, each for electrically connecting to a corresponding memory card; and
a controller, for issuing a disconnect signal through said connection interface to said host after said host completing enumeration, and by issuing an optional reconnect signal belonging to said card reader to said host to enable said host executing the re-enumeration and adjusting the displaying of the access interface available in said card reader.

2. The card reader as claimed in claim 1, wherein said connection interface is a USB interface and said controller is a USB controller.

3. The card reader as claimed in claim 1, wherein said memory card is secured digital (SD) card, Mini SD card, multimedia card (MMC), reduced-size MMC (RS-MMC), TransFlash (T-Flash), Mega-SIM card, smart media (SM) card, memory stick (MS) card, MS Pro, MS Duo, MS Pro Duo, M2 card, compact flash (CF), or XD picture memory card

4. The card reader as claimed in claim 1, wherein said access interfaces are interfaces supporting access to can be secured digital (SD) card, Mini SD card, multimedia card (MMC), reduced-size MMC (RS-MMC), TransFlash (T-Flash), Mega-SIM card, smart media (SM) card, memory stick (MS) card, MS Pro, MS Duo, MS Pro Duo, M2 card, compact flash (CF), or XD picture memory card.

5. The card reader as claimed in claim 1, wherein according to whether a memory card is plugged into said access interfaces, when said controller issues a disconnected signal and optionally issues a reconnected signal belonging to said card reader to said host, said host executes re-enumeration and only displays said access interfaces having memory card plugged into.

6. The card reader as claimed in claim 1, wherein according to whether a memory card is plugged into said access interfaces, when said controller issues a disconnected signal and optionally issues a reconnected signal belonging to said card reader to said host, said host executes re-enumeration and only displays said access interface having memory card plugged into and with highest priority according to the priority of said access interfaces.

7. The card reader as claimed in claim 1, wherein according to whether a memory card is plugged into said access interfaces, when said controller issues a disconnected signal and optionally issues a reconnected signal belonging to said card reader to said host, said host executes re-enumeration and displays said access interfaces having memory card plugged into in the order of the priority of said access interfaces.

8. The card reader as claimed in claim 1, wherein according to whether a memory card is plugged into said access interfaces, when said controller issues a disconnected signal and the data access may be erroneous, said controller does not issues a reconnected signal to avoid the data error or loss caused by accessing said memory card.
